(19) United States
(12) Patent Application Publication
(10) Pub. No.: US 2012/0173332 A1
(43) Pub. Date: Jul. 5, 2012

(54) METHOD AND SYSTEM FOR PROMOTING AND MARKETING MORE ENVIRONMENTAL FRIENDLY PRINTING

(75) Inventors: Isao HAYAMI, Kanagawa (JP); Naoki KOMINE, Hawthorne, CA (US)

(73) Assignee: KONICA MINOLTA SYSTEMS LABORATORY, INC., Huntington Beach, CA (US)

(21) Appl. No.: 12/982,752

(22) Filed: Dec. 30, 2010

(51) Int. Cl. G06Q 30/00

(52) U.S. Cl. 705/14.49

(57) ABSTRACT

A method and system for promoting and marketing more environmental friendly print shops through a process carried out by an online platform. The process includes the steps of receiving a print job request with particular specifications from a customer, retrieving from a database profiles of participating print shops to determine which print shops can handle the print job, calculating a job-level green score based on the particular specifications of the print job request for each such print shop, and recommending to the customer a list of print shops that can handle the print job with a ranking of their job-level green scores. The process may also include the steps of collecting information and data from the print shops to prepare their profiles and calculate a shop-level green score for each print shop based on a set of environmental friendly factors, and storing the profiles in a database, and recommending the print shops that can handle the print job based on a ranking of total green score.

### BACKGROUND OF THE INVENTION

1. Field of the Invention

This invention relates generally to method and system for printing management and in particular, it relates to method and system for making printing more environmentally friendly.

2. Description of Related Art

Many printing jobs today are processed by “print shops”, which refers to an environment of professional print shops, publishing workshops, print/copy departments of large organizations or business entities, and/or press unit of educational institutions such as colleges and universities, where a variety of print job requests such as large-volume duplication or document printing needs to be processed and completed by utilizing multiple printers within a specified turn-around time.

There is a growing effort to make print shops more “green”, which means that the print shops will complete print jobs in a more environmentally friendly manner. For example, more energy efficient printers are increasingly installed in print shops, and recycled papers are more often used for various print jobs. This is also a growing need for providing an online platform for environmentally conscious consumers to find and select more environmentally friendly print shops for their print jobs, and for more environmentally friendly print shops to be encouraged and rewarded for more business from environmentally conscious consumers.

### SUMMARY

The present invention is directed to a method and system for promoting and marketing more environmental friendly printing.

An object of the present invention is to provide an online platform or portal for environmentally conscious consumers to find and select more environmentally friendly print shops for their print jobs, and for more environmentally friendly print shops to be encouraged and rewarded for more business from environmentally conscious consumers.

To achieve these and/or other objects, as embodied and broadly described, the present invention provides a method and system for promoting and marketing more environmental friendly print shops through a process carried out by an online platform. The process includes the steps of receiving a print job request with particular specifications from a customer, retrieving from a database profiles of participating print shops to determine which print shops can handle the print job, calculating a job-level green score based on the particular specifications of the print job request for each such print shop, and recommending to the customer a list of print shops that can handle the print job with a ranking of their total green scores. The process may also include the steps of collecting information and data from a multiplicity of participating print shops to prepare profiles of these participating print shops, calculating a shop-level green score for each print shop based on a set of environmental friendly factors, and storing the profiles in a database, and recommending the print shops that can handle the print job with a ranking of a total green-score.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online platform for customers to use environmental friendly print shops where embodiments of the present invention may be implemented.

FIG. 2 is a schematic block diagram illustrating an exemplary customer computer system for accessing the online platform according to an embodiment of the present invention.

FIG. 3 is a schematic block diagram illustrating an exemplary print shop server and printers connected to the online platform according to an embodiment of the present invention.

FIG. 4 is a flow chart showing an exemplary process implementing a method for promoting and marketing environmental friendly print shops through an online platform according to an embodiment of the present invention.

### DETAILED DESCRIPTION OF PREFERRED EMBODIMENTS

Embodiments of the present invention provide a method and system for promoting and marketing environmental friendly print shops. The present invention method may be implemented by a computer software program that has program codes and instructions for implementing the steps of the present invention.

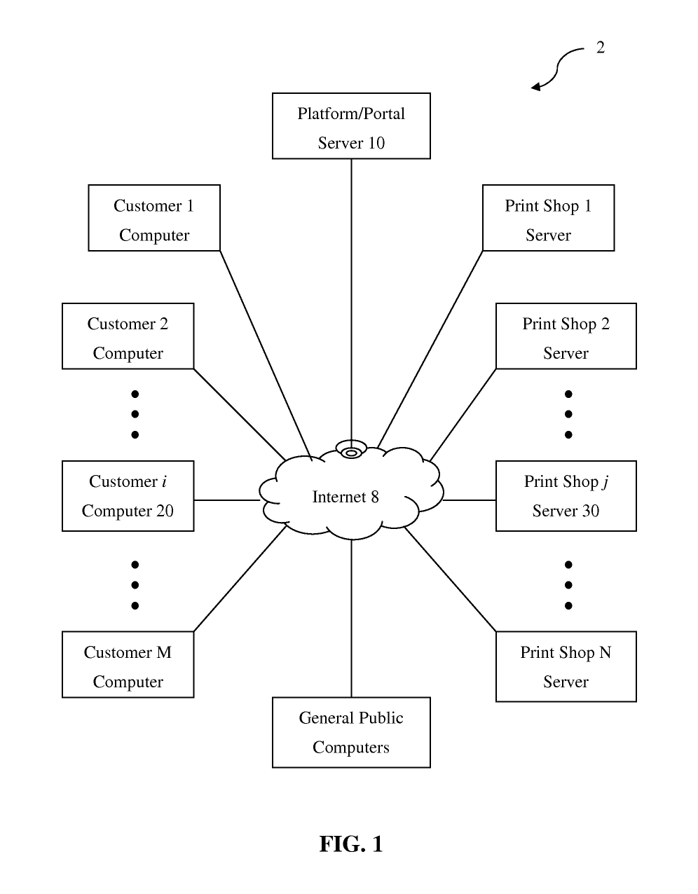

Referring to FIG. 1, there is shown a schematic block diagram illustrating an exemplary system set up or arrangement 2 in which various embodiments of the present invention may be implemented. The present invention set up or arrangement 2 includes an online service for promoting and marketing environmental friendly printing. The environmentally friendly printing promotion and marketing service is provided by utilizing one or more servers 10 which is connected to an open computer network such as the Internet 8, where the computer program implementing the present invention process is installed and executed to provide an online platform or portal to promote and market environmental friendly printing. The platform server 10 is connected via the Internet 8 with a multiplicity of computers of consumers 1, 2, . . . , i, . . . , M respectively, where computer 20 of consumer i is representative and will be described in detail below. The platform server 10 is also connected via the Internet 8 with a multiplicity of servers of print shops 1, 2, . . . , j, . . . , N respectively, where server 30 of print shop j is representative and will be described in detail below.

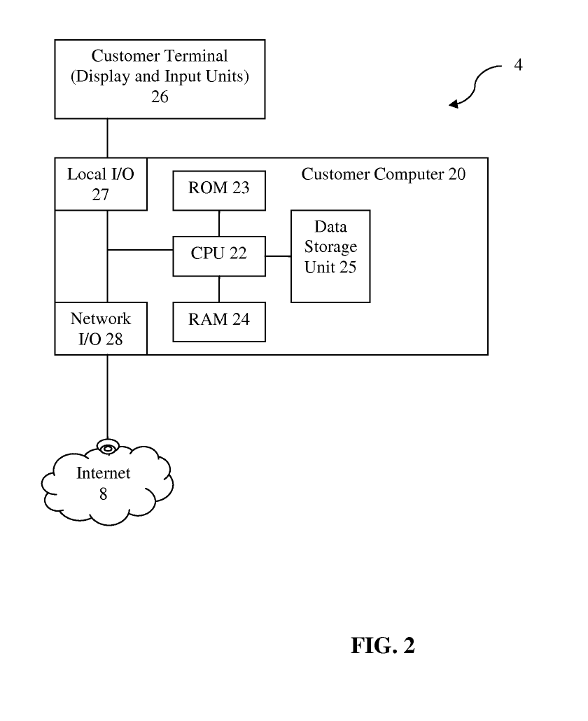

Referring to FIG. 2, there is shown a schematic block diagram illustrating an exemplary set up or arrangement 4 of a customer computer 20, whereupon various embodiments of the present invention may be implemented. The customer computer 20 typically includes a central processor unit (CPU) 22 that controls the function and operation of the computer 20 and execute computer instructions and programs that may be installed or saved on a read only memory (ROM) 23, a random access memory (RAM) 24, or a data storage unit 25 (such as a hard disc drive or a flash memory) coupled to the CPU 22. One or more user terminals 26 (each may have its display and input units) may be connected to the computer 20 to enable a customer and/or user to interact with the computer 20. Alternatively the computer 20 may have its own integrated display and input units to enable a customer or user to interact with the computer 20. The computer 20 typically also has a local input/output (I/O) port 27 for connection with the user terminal 26, and a network I/O port 28 for connection to a network such as the Internet 8 so the computer 20 may remotely communicate with the platform server 10 and print shop servers 30. It is understood that customer computer 20 may be any suitable computer, such as a desktop computer, a laptop computer, a server, a netbook computer, a tablet computer such as iPad®, or any suitable data processing apparatus including but not limited to smart-phones such as iPhone®, iPod Touch® and other handheld devices that have suitable data processing capabilities.

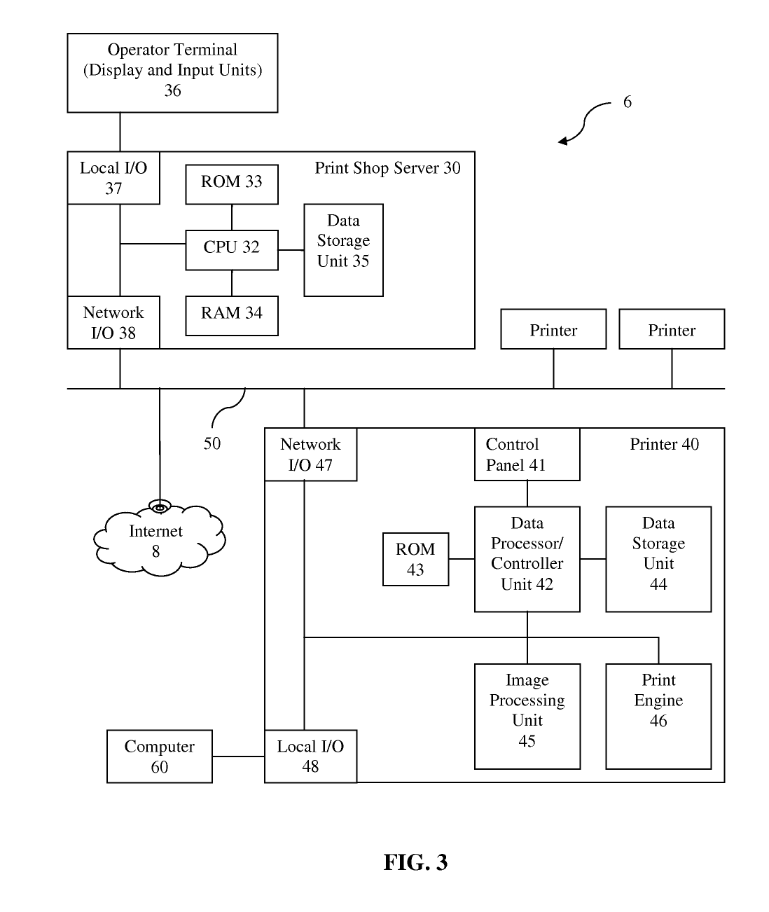

Referring to FIG. 3, there is shown a schematic block diagram illustrating an exemplary print shop printing system set up or arrangement 6, whereupon various embodiments of the present invention may be implemented. In this patent application the term “print shop” refers to an environment of professional print shops, publishing workshops, print/copy departments of large organizations or business entities, and press unit of educational institutions such as colleges and universities, where a variety of print on demand (POD) requests, such as large-volume duplication and large document printing, needs to be processed and completed by utilizing multiple printers within a specified turn-around time.

In the exemplary print shop printing system set up or arrangement 6, a multiplicity of color and/or black and white printers are connected to and controlled by the printer shop server 30 through a data communication channel 50 which may be a wired or wireless network, a serial bus or a dedicated cable. One or more of the printers, such as printer 40, may also be directly connected to and controlled by a computer 60. Other devices (not shown) may also be connected to the server 30, the computer 60 or network channel 50, such as scanners, finishing devices, etc., as part of the printing system set up or arrangement 6. The print shop system 6 may also include a number of “off-line” (or “off-network”) devices (not shown) that are not connected to the network 16, which devices may be any type of devices used in the print shop, such as finishing devices, prepress devices, etc.

In this application the term “printer” may refer to small desk-top printers typically seen in an office environment, or large digital printing systems used in print/copy departments at large organizations or professional print shops. The term may also cover other similar image and document processing devices such as copiers or multifunction (“all-in-one”) printers that also have copier, scanner and/or facsimile functions. The printer may be directly attached to a computer or server locally, or connected to a computer or server through a network remotely, where the computer or server are used to manage a print job to be processed by the printer. The printer may have multiple paper trays to store paper of various sizes, color, and types. Further, the printer may be equipped with a sophisticated output sorting mechanism with multiple output trays to perform collate printing or other print finishing functions.

As shown in FIG. 3, the print shop server 30 typically includes a central processor unit (CPU) 32 that controls the function and operation of the server 30 and execute computer instructions and programs that may be installed or saved on a read only memory (ROM) 33, a random access memory (RAM) 34, or a data storage unit 35 (such as a hard disc drive) coupled to the CPU 32. One or more print shop operator terminals 36 (each may have its display and input units) may be connected to the server 30 to enable print shop operators and/or users to interact with the server 30 and/or the rest of the print shop system 6. Alternatively the server 30 may have its own integrated display and input units to enable print shop operators and/or users to interact with the server 30 and/or the rest of the print shop system 6. The server 30 typically has a local input/output (I/O) port 37 for connection with the user terminal 36, and a network I/O port 38 for connection to the data communication channel 50. Through the network channel 50 the server 30 is also connected to the external computer network such as the Internet 8 so the server 30 can remotely communicate with the platform server 10 and customer computers 20.

As also shown in FIG. 3, the printer 40 typically has a control panel 41, a controller or control unit 42 which controls the other internal units of printer 40 and is connected to the control panel 41, read-only memory (ROM) 43 and a data storage unit 44. The control panel 41 is accessible by a user and may include a display screen such as a liquid crystal display (LCD) display screen and user input means such as keys, buttons, touch screen, etc., for a user to communicate with and control the function and operation of printer 40. The printer 40 also has an image processing unit 45 and a print engine 46. The printer 40 typically has a network input/output (I/O) port 47 for connection with the print shop server 30, and a local I/O port 48 for optionally connecting to the local computer 60.

It is understood that while FIG. 3 shows a print shop environment, the present invention is not limited to any physical setting of a print shop or network, and can be applied to a printing system having a distributed setting where printers at different locations are connected to one print shop server. In particular, it should be apparent that one or more of the components of the printing system can communicate with the rest of the system via virtual private network (VPN) or similar means through the Internet 8.

The present invention provides an online service for promoting and marketing environmental friendly printing preferably by operating an online platform or portal on the platform server 10. The computer software program that implements the present invention method and process may be installed on the platform server 10, and its application modules or client-end component parts may be installed on the customer computers 20 and/or printer shop servers 30 (or on the printer 40 or computer 60). When a platform server operator executes the exemplary software program of the present invention, the platform server 10 carries out various respective functions of the software to perform the platform service provider part of the exemplary process of the present invention. When a customer executes an application module of the exemplified software program of the present invention from the customer's end, the customer computer 20 carries out various respective functions of the software to perform the customer part of the exemplary process of the present invention. When a print shop operator executes an application module of the exemplified software program of the present invention from the print shop's end, the printer shop server 30 carries out various respective functions of the software to perform the print shop part of the exemplary process of the present invention. Together the execution of the various application modules of the exemplary software program of the present invention by the platform server 10, customer computers 20 and/or printer shop servers 30 cause the performance and completion of the exemplary method and process of the present invention described below.

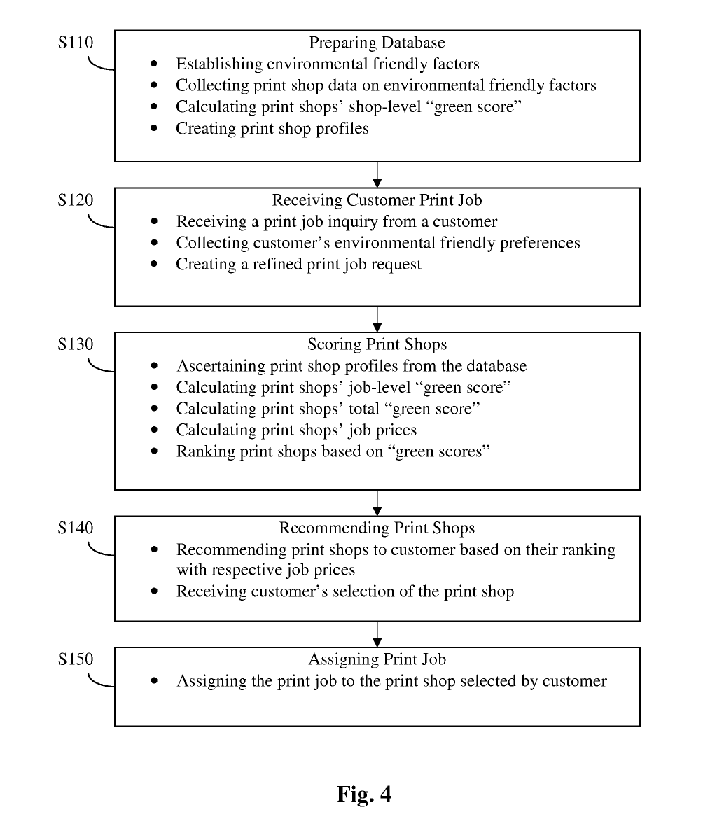

Referring to FIG. 4, there is illustrated an exemplary method and process of the present invention, which generally includes the basic steps of: a data preparation step during which available profiles of the print shops including environmental friendly factors are gathered, sorted and stored in a database (Step S110), a customer requesting step during which a customer is inquiring about a print job and seeking print shop information related to environmental friendly factors (Step S120), an evaluation and scoring step during which print shops are evaluated and scored based on the environmental friendly factors and the particular print job requested by the customer (Step S130), a recommendation step during which print shops with favorable environmental friendly scores, as well as options to make the print job more environmental friendly, are recommended to the customer (Step S140), and a print job assignment step during which the print job is assigned and forwarded to the print shop selected by the customer (Step 150).

According to one embodiment of the present invention method and process, in the data preparation stage (Step S110), the platform service provider will first establish a set of environmental friendly factors for evaluating print shops and print jobs. Such factors may include the power consumption of a print shop as compared to their capacity, the number or percentage of energy-efficient printers installed, CO₂ emission of the print shop, the type of papers (e.g., recycled paper) used, the type of toners/inks (e.g., non-toxic, more sustainable, biodegradable) used, fuel or energy efficient delivery methods used, etc. These factors may be standardized or averaged to provide a more consistent and objective evaluation of the print shops, For example, monthly overall electricity usage may be calculated on a price per watt basis. This may also apply to other shop related costs items. These factors are used to evaluate how environmental or “eco”-friendly, or “green”, a print shop is. Information and data related to these factors may be collected by the platform server 10 from the print shop servers 30 via the Internet 8, or alternatively be submitted to the platform server 10 via the Internet 8 from the print shop server 30 of participating print shops. The collected or submitted information and data are stored in the database as the profiles of the print shops, from which a shop-level “green score” can be calculated for and assigned to each participating print shop. The shop-level green score of a print shop will be used later when a total green score is calculated. As a person who is skilled in the relevant art will appreciate, Step 110 does not need to be executed every time the exemplary method or process is executed. In other words, once the available profiles of the print shops have been gathered and the database is built up, the method or process may be initiated from Step 120 next time. However, the database and profiles of the participating print shops may be updated periodically or as needed either by the online platform provider or the print shops, or automatically by software programs executed on the platform server 10 and/or the print shop servers 20.

In the next step (Step S120), the online platform receives a print job inquiry from a customer. The customer may use a customer computer 20 to log-on to a website provided by the platform server 10 through the Internet 8. The platform server 20 will execute the exemplary software program of the present invention to allow the customer's input and submission of the print job inquiry. Alternatively the customer may execute a customer-end application module of the exemplary software program of the present invention on the customer's computer 20 to generate a print job inquiry and send it to the platform server 10 through the Internet 8. The initial print job inquiry may include print job specifications such as the type of printing wanted (color, black and white, mixed, etc.), the finishing requirements (e.g., stapled, bounded, etc.), the quantity, the time the print job needs to be done (turn-around time or deadline), delivery location, etc. The software program may provide initial feedback or further questions to the customer about the customer's environmental friendly preferences, for example whether the customer is willing to use recycled paper, a particular type of tone/ink, etc. Sometimes choosing more environmental friendly options may cause more for the print job, for example due to increased costs of the printer, paper or toner/ink. So the customer may be asked whether the customer is willing to pay more for the print job that is done more environmental friendly or by a more environmental friendly print shop. Based on the further input/answer from the customer, a refined print job request is finalized and created.

In the next step (Step S130), the exemplary software program of the present invention running on the platform server will retrieve print shop profiles from the database to see what print shops are suitable for the refined print job request, which may depends on a particular print shop's availability, capacity, location, etc. For the print shops that can handle the print job requests, a job-level “green score” is calculated for each print shop. The job-level scores are specific to the print job request. For example, if the customer has specified a particular thickness of paper to be used, it may affect power usage of the print job (e.g., more heat needs to be generated by the printer to affix toner on thicker paper, which consumes more power). If a print shop has an energy efficient printer that can handle this type of paper required by the particular print job, than the print shop may earn a higher job-level “green score”. Once a job-level green score is calculated for each print shop that can handle the print job request, it is combined with the shop-level green score of the print shop to yield a “total green score”. Finally, all participating print shops that can handle the print job request are ranked based on their total green scores. In addition to this, ranking of the print shops based on their job-level green scores may be calculated.

In the next step (Step S140), the participating print shops that can handle the print job request are recommended to the customer with their rankings of the total green scores and/or the job-level green scores. The platform server 10 may send this recommendation to the customer's computer 20 via the Internet 8, or the customer may log-on the platform server 10 via the Internet 8 from the customer's computer 20 to obtain the recommendation. The customer can then make a selection of the print shop by which the customer wants to have the print job handled. In addition to the recommendation, a suggestion may be provided to change or modify some of the print job specifications to reduce the prices and/or carbon foot prints of the print job. For the purpose of providing this suggestion, in Step S120, the customer may specify the print job specifications with their degrees of desires. That is to say, a particular specification with lower desire degree may be higher candidate when providing the suggestion to change or modify the print job specifications.

In the last step of the present invention process (Step 150), the platform server 10 will forward the print job request via the Internet 8 to the print shop server 20 of the print shop selected by the customer, so the print shop can go ahead print the job. Alternatively, the customer may send the print job request directly from the customer computer 10 via the Internet 8 to the print shop server 20 of the print shop selected by the customer.

The above described exemplary method and process according to the present invention has many advantages. It provides a convenient way for a customer to select a more environmental friendly print shop to handle a print job based on objective and measurable criteria and factors. It also provides an effective way to promote and reward a more environmental friendly print shop with increase amount of visibility and business. It further encourage print shop to be more environmental friendly.

It will be apparent to those skilled in the art that various modification and variations can be made to the methods of the present invention without departing from the spirit or scope of the invention. Thus, it is intended that the present invention cover modifications and variations that come within the scope of the appended claims and their equivalents.

What is claimed is:

1. A method for promoting and marketing more environmental friendly print shops, comprising the steps of:
a. receiving a print job request with particular specifications from a customer;
b. retrieving from a database profiles of a multiplicity of participating print shops to determine which print shops can handle the print job;
c. calculating a job-level green score based on the particular specifications of the print job request for each such print shop that can handle the print job; and
d. recommending to the customer a list of print shops that can handle the print job with a ranking of their job-level green scores.

2. The method according to claim 1, further comprising a step of collecting information and data from the participating print shops to prepare their profiles and storing the profiles in the database

3. The method according to claim 2, further comprising a step of calculating a shop-level green score for each print shop based on a set of environmental friendly factors.

4. The method according to claim 3, further comprising a step of combining the shop-level green score and the job-level green-score of each print shop that can handle the print job to calculate a total green score of each such print shop.

5. The method according to claim 4, further comprising a step of recommending to the customer a list of print shops that can handle the print job with a ranking of their total green scores.

6. The method according to claim 2, further comprising a step of updating the information and data and the profiles of the participating print shops.

7. The method according to claim 1, further comprising a step of receiving a selection by the customer of a print shop from the recommended list.

8. The method according to claim 7, further comprising a step of assigning the print job request to a print shop selected by the customer.

9. The method according to claim 3, further comprising a step of establishing the set of environmental friendly factors.

10. The method according to claim 1, further comprising a step of providing an online platform to carry out one or more of the steps.

11. A system for promoting and marketing environmental friendly print shop comprising at least one data processing apparatus having a non-transitory memory storing a computer software program and a processor executing the computer software program, wherein the computer software program includes program code configured to cause the at least one data processing apparatus to execute a process which comprises the steps of:
a. receiving a print job request with particular specifications from a customer;
b. retrieving from a database profiles of a multiplicity of participating print shops to determine which print shops can handle the print job;
c. calculating a job-level green score based on the particular specifications of the print job request for each such print shop that can handle the print job; and
d. recommending to the customer a list of print shops that can handle the print job with a ranking of their job-level green scores.

12. The system according to claim 11, wherein the process further comprises a step of collecting information and data from the participating print shops to prepare their profiles and storing the profiles in the database

13. The system according to claim 12, wherein the process further comprises a step of calculating a shop-level green score for each print shop based on a set of environmental friendly factors.

14. The system according to claim 13, wherein the process further comprises a step of combining the shop-level green score and the job-level green-score of each print shop that can handle the print job to calculate a total green score of each such print shop.

15. The system according to claim 14, wherein the process further comprises a step of recommending to the customer a list of print shops that can handle the print job with a ranking of their total green scores.

16. The system according to claim 11, wherein the process further comprises a step of updating the information and data and the profiles of the participating print shops.

17. The system according to claim 11, wherein the process further comprises a step of receiving a selection by the customer of a print shop from the recommended list.

18. The system according to claim 17, wherein the process further comprising a step of assigning the print job request to a print shop selected by the customer.

19. The system according to claim 13, wherein the process further comprises a step of establishing the set of environmental friendly factors.

20. The system according to claim 11, wherein the process further comprises a step of providing an online platform to carry out one or more of the steps of the process.

21. A computer software program product having a computer readable program code embedded in a computer usable non-transitory storage medium for controlling at least one data processing apparatus, the computer readable program code configured to cause the at least one data processing apparatus to execute a process for promoting and marketing environmental friendly print shops comprising the steps of:
a. receiving a print job request with particular specifications from a customer;
b. retrieving from a database profiles of a multiplicity of participating print shops to determine which print shops can handle the print job;
c. calculating a job-level green score based on the particular specifications of the print job request for each such print shop; and
d. recommending to the customer a list of print shops that can handle the print job with a ranking of their total green scores.

22. The computer software program product according to claim 21, wherein the process further comprises a step of collecting information and data from the participating print shops to prepare their profiles and storing the profiles in the database

23. The computer software program product according to claim 22, wherein the process further comprises a step of calculating a shop-level green score for each print shop based on a set of environmental friendly factors.

24. The computer software program product according to claim 23, wherein the process further comprises a step of combining the shop-level green score and the job-level green-score of each print shop that can handle the print job to calculate a total green score of each such print shop.

25. The computer software program product according to claim 24, wherein the process further comprises a step of recommending to the customer a list of print shops that can handle the print job with a ranking of their total green scores.

26. The computer software program product according to claim 21, wherein the process further comprises a step of updating the information and data and the profiles of the participating print shops.

27. The computer software program product according to claim 21, wherein the process further comprises a step of receiving a selection by the customer of a print shop from the recommended list.

28. The computer software program product according to claim 27, wherein the process further comprising a step of assigning the print job request to a print shop selected by the customer.

29. The computer software program product according to claim 23, wherein the process further comprises a step of establishing the set of environmental friendly factors.

30. The computer software program product according to claim 16, wherein the process further comprises a step of providing an online platform to carry out one or more of the steps of the process.
